(19) United States
(12) Patent Application Publication
(10) Pub. No.: US 2006/0237968 A1
(43) Pub. Date: Oct. 26, 2006

(54) High efficiency power converter for energy harvesting devices

(75) Inventor: Sriram Chandrasekaran, Westlake Village, CA (US)

Correspondence Address: John J. Deinken;ROCKWELL SCIENTIFIC COMPANY LLC, Mail Code A15, P.O. Box 1085, Thousand Oaks, CA, 91358-0085, US

(73) Assignee: Rockwell Scientific Licensing, LLC

(21) Appl. No.: 11/111,128

(22) Filed: Apr. 20, 2005

(51) Int. Cl. H02K 7/18; F03G 7/08; F02B 63/04

(52) U.S. Cl. 290/1 R

(57) ABSTRACT

A high-efficiency power converter converts the unregulated AC electrical energy generated by an energy harvesting device to regulated quasi-continuous DC or AC power delivered to a load. A DC link capacitor stores energy from the AC input. Control electronics alternately transfers regulated power to the load and recharges the capacitor in accordance with a hysteresis window in the capacitor energy. The control electronics terminates transfer of regulated power to the load and initiates recharging of the capacitor when the capacitor voltage, hence energy falls below a lower threshold and terminates capacitor charging and initiates power transfer when the capacitor voltage, hence energy exceeds an upper threshold.

### BACKGROUND OF THE INVENTION

1. Field of the Invention

This invention relates to energy harvesting devices that convert mechanical excitation into regulated electrical power suitable for useful work and more specifically to a high-efficiency power converter that converts the unregulated AC electrical energy generated by the energy harvesting device to regulated DC or AC power.

2. Description of the Related Art

Several energy harvesting systems have been developed to convert mechanical excitation into regulated electrical power suitable for useful work. The mechanical excitation may be imparted by wave motion in a body water, pneumatic pressure, motion of a vehicle, shock, stress, etc. The mechanical excitation will typically fluctuate randomly in both amplitude and frequency. Energy harvesting devices such as piezoelectric transducers or electromagnetic transducers convert mechanical excitation energy into unregulated AC electrical energy. Control electronics then convert the unregulated AC energy into regulated DC or AC power that can be delivered to a load, typically a battery.

Piezoelectric transducers are made of materials, which possess the property of being able to transform mechanical force and displacement into electrical energy. When stressed in one direction and then in an opposite direction, piezoelectric transducers produce electric energy in the form of an alternating voltage. The amplitude and frequency of the generated electric signal may vary considerably. The amplitude of the generated electrical signal is a function of the size of the piezoelectric device and the level of stress applied thereto. The frequency of the generated electrical signal is a function of the frequency of the stress and strain to which the piezoelectric device is subjected. U.S. Pat. Nos. 4,404,490 and 4,685,296 are examples of piezoelectric transducers for generating power from surface waves. The electromagnetic transducer works by moving a magnet through a conductive coil to induce an AC voltage across the terminals of the coil. See U.S. Pat. Nos. 4,260,901; 5,347,186; 5,818,132; and 6,798,090.

U.S. Pat. No. 5,703,474 assigned to Ocean Power Technologies (OPT) provides control electronics for optimizing the transfer of energy produced by a piezoelectric transducer to a load. The electric energy generated by a piezoelectric device (PEG), when mechanically stressed, is transferred from the PEG to a storage element (e.g., a capacitor or a battery) by selectively coupling an inductor in the conduction path between the PEG and the storage element. In one embodiment, the transfer of energy is optimized by allowing the amplitude of the electric signal to reach a peak value before transferring the electrical energy via an inductive network to a capacitor or a battery for storage. Electrically, the PEG is operated without significant loading (e.g., essentially open circuited) when the amplitude of the voltage generated by the PEG is increasing. When the amplitude of the voltage has peaked, or reached a predetermined value, the electrical energy generated by the PEG is coupled to an inductive-capacitive network for absorbing and storing the energy produced by the PEG.

OPT's control electronics transfer energy to the load at the peak of each cycle of the rectified input. The restraining force created as a natural consequence of power transfer to a load rapidly depletes the voltage across the transducer. Because the control electronics use an inductor to regulate current, the current, hence the transducer voltage must drop all the way to zero before a new energy transfer cycle can commence. Consequently the piezoelectric transducer is shut down at each cycle and must restart. This interruption in power transfer limits the efficiency of the energy conversion process from the input mechanical energy to regulated electrical energy. In addition, the volume and weight of the inductor can be large, especially at low frequencies to provide sufficient energy storage between the input and output.

It is desirable for energy harvesting systems to minimize the energy lost in the power converter and controlling electronics and minimize the size and weight of the power converter and controlling electronics, deliver generated electrical energy in a well regulated and, preferably, quasi-continuous manner, and require no external power source for controlling the power converter.

### SUMMARY OF THE INVENTION

The present invention provides a high-efficiency power converter that converts the unregulated AC electrical energy generated by an energy harvesting device to regulated quasi-continuous DC or AC power delivered to a load.

This is accomplished with an energy harvesting device such as an electromagnetic or piezoelectric transducer that converts mechanical energy from an excitation force into unregulated AC electrical energy in the form of an AC voltage or current. The rectified AC signal charges a DC link capacitor. The control electronics alternately transfers regulated power to the load and recharges the capacitor in accordance with a hysteresis window in the capacitor voltage, hence energy. The control electronics terminates transfer of regulated power to the load and initiates recharging of the capacitor when the capacitor voltage, hence energy falls below a lower threshold and terminates capacitor charging and initiates power transfer when the capacitor voltage, hence energy exceeds an upper threshold. This approach delivers power in a more continuous manner at higher efficiencies and power densities than previous techniques. A plurality of these modules may be used to harvest the AC electrical energy by shifting them in phase with respect to each other and adding their regulated outputs at the load terminals.

In an exemplary embodiment, the control electronics includes a regulator that converts the unregulated DC voltage across the DC link capacitor to a regulated electrical signal, e.g. a voltage or current, as required by the load. A hysteretic comparator turns the regulator on when the DC link capacitor voltage exceeds the upper threshold and off when the unregulated DC voltage falls below the lower threshold. The control electronics may also include a low power linear voltage regulator that extracts power from the DC link capacitor to provide bias power for the electronics.

The upper and lower thresholds are set based on knowledge of both the unregulated AC electrical energy supplied by the mechanical excitation force and the load requirements. It is generally desirable to have a wide hysteresis window to increase the likelihood that the device will settle at an operating point at which the load power can be continuously provided by the input mechanical excitation. The constraints are that the lower threshold must be high enough to avoid stalling the energy harvesting device and the severe disruption in power transfer that follows and the upper threshold should be low enough that it is reached in a reasonable period of time for a given DC link capacitor value.

These and other features and advantages of the invention will be apparent to those skilled in the art from the following detailed description of preferred embodiments, taken together with the accompanying drawings, in which:

### BRIEF DESCRIPTION OF THE DRAWINGS

FIG. 1 is a diagram of an energy harvesting system for efficiently harvesting energy from surface waves;

FIG. 2 is a plot of the AC coil voltage;

FIG. 3 is a block diagram of the system and high-efficiency converter;

FIG. 4 is a plot of the rectified coil voltage and the DC link capacitor voltage;

FIGS. 5a and 5b are diagrams illustrating the transfer of regulated power to the load and recharging of the DC link capacitor in accordance with a hysteresis window in the capacitor energy;

FIG. 6 is a diagram of an energy harvesting system using a pair of coils and power converters;

FIG. 7 is a diagram illustrating the relationship of the DC link capacitor voltage and the modulated load power for the pair of coils;

FIG. 8 is a schematic diagram of an op-amp based hysteretic comparator; and

FIG. 9 is a schematic diagram of a switching converter.

### DETAILED DESCRIPTION OF THE INVENTION

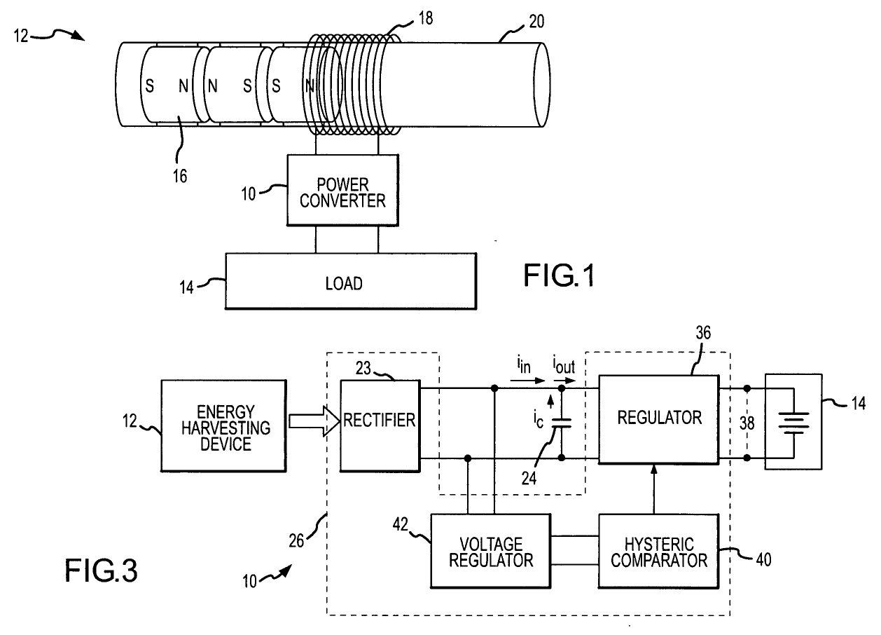

As shown in FIG. 1, the present invention provides a high-efficiency power converter 10 that converts the unregulated AC electrical energy generated by an energy harvesting device 12 to regulated quasi-continuous DC or AC power delivered to a load 14. The energy harvesting device 12 may be an electromagnetic transducer, a piezoelectric transducer or any other transducer capable of converting mechanical excitation energy into unregulated AC electrical energy.

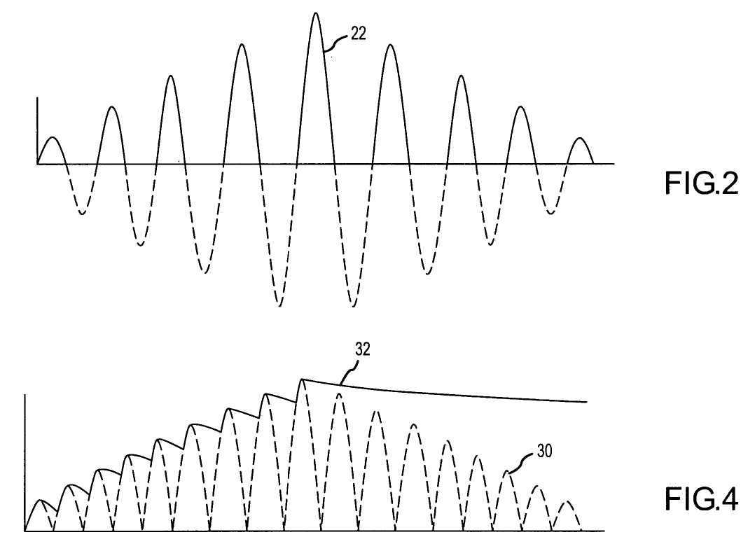

In this particular embodiment, the energy harvesting device 12 is an electromagnetic transducer that works by moving one or more magnets 16 through a conductive coil 18 to induce a voltage across the terminals of the coil. As the magnet is moved back and forth in a reciprocating motion inside a tube 20, such as might be caused by the motion of surface waves, the polarity of the voltage in the coil will be reversed for each successive traverse, yielding an AC voltage 22, in accordance with Faraday's law, as shown in FIG. 2. The amplitude and frequency of the AC voltage is a function of the velocity and magnetic field strength of the magnet and the number of turns of the coils. The AC voltage will track the mechanical excitation force and velocity of the magnets; hence both its amplitude and frequency will in general tend to fluctuate randomly.

Power is transferred from the coil 18 to load 14, thereby performing useful work, when current flows through the coil. The coil current generates a restraining force opposing the excitation force in accordance with Lenz law. The magnitude of the restraining force is proportional to the coil current and field strength of the magnet column. If the restraining force is greater than the excitation force, the magnet column will decelerate and eventually stall. The generation of such a restraining force is common to all energy harvesting devices, without the creation of a restraining force power cannot be transferred to the load.

The input excitation force or the velocity of the magnet column, hence the input power is not immediately measurable without the expenditure of energy and loss of efficiency. As a result, as shown in FIG. 3 the power converter 10 includes control electronics 26 that by sensing the voltage across a DC link capacitor 24, determines when the magnet column has accelerated enough to start drawing power from the coil and to stop drawing power when the magnet column has decelerated to a preset lower bound velocity. This is accomplished with a hysteretic on-off control mechanism.

A rectifier 23 rectifies AC voltage 22 to provide a rectified AC voltage 30 (FIG. 4) for charging the DC link capacitor to provide an unregulated DC voltage 32 (FIG. 4). The DC link capacitor 24 integrates and stores the AC electrical energy over a number of cycles. The capacitor will essentially hold the highest voltage from the rectified AC input until energy is transferred to the load. The rectifier can be a full-wave, half-wave, or full-wave center-tapped diode rectifier, full-wave, self-driven center tapped synchronous rectifier or other rectifier configuration.

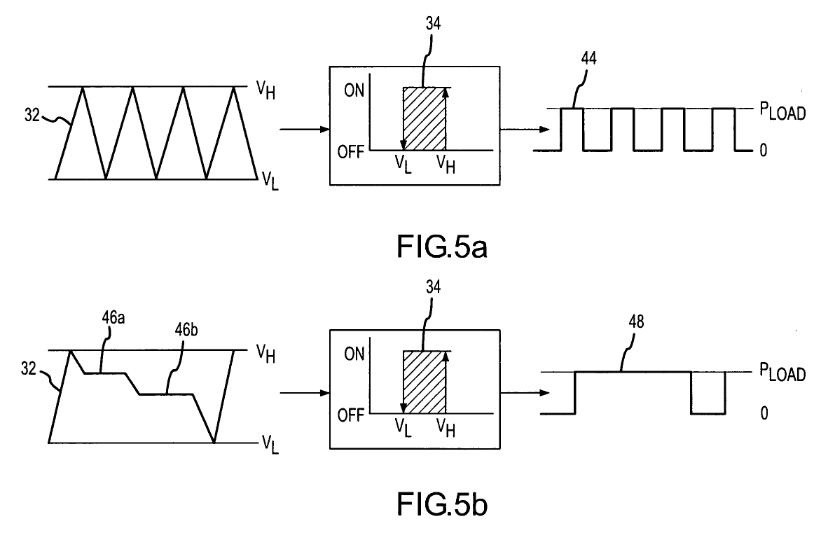

Control electronics 26 alternately transfers regulated power to the load 14 and recharges the capacitor 24 in accordance with a hysteresis window 34 in the capacitor voltage (or energy) as depicted in FIGS. 5a and 5b. The control electronics terminates transfer of regulated power to the load and initiates recharging of the capacitor when the capacitor voltage 32 falls below a lower threshold VL and terminates capacitor charging and initiates power transfer when the capacitor voltage exceeds an upper threshold VH. This approach delivers power in a more continuous manner at higher efficiencies than previous techniques.

In an exemplary embodiment, control electronics 26 includes a regulator 36 that converts the unregulated DC voltage 32 across the DC link capacitor to a regulated electrical signal 38, e.g. a voltage or current, as required by the load. A hysteretic comparator 40 turns the regulator 36 on when the DC link capacitor voltage 32 exceeds the upper threshold V_{H} and off when the unregulated DC voltage falls below the lower threshold V_{L}. A low-power linear voltage regulator 42 extracts energy from the DC link capacitor to provide bias power to the control electronics. The voltage regulator may be omitted if a battery or other power source is available to provide bias power to the control electronics. The low power linear regulator, however, renders the power converter to be “self-driven”.

As the capacitor voltage increases from VL to VH, the net energy stored in the capacitor from the input mechanical excitation is given by:

$${E}_{stored} = ( \frac{1}{2} {CV}_{H}^{2} - \frac{1}{2} {CV}_{L}^{2} )$$

where

$$\frac{1}{2} {CV}_{H}^{2}$$

is the energy in the DC link capacitor when the voltage reaches the upper threshold and

$$\frac{1}{2} {CV}_{L}^{2}$$

is the energy when the voltage hits the lower threshold.

When the capacitor voltage reaches VH, the regulator is turned on and pload is provided to the load. “pload+regulator losses” is now drawn from the capacitor and the electromagnetic transducer through the rectifier. If the capacitor voltage reduces from VH, it means that the capacitor is discharging and providing current ic to the load as shown in FIG. 3. The load power pload requires a current iₒᵤₜ to be drawn at the input of the regulator 36, which is the sum of i_{C} from the capacitor and iᵢₙ from the rectifier. When the capacitor voltage reaches V_{L}, the hysteretic comparator shuts the regulator down and the capacitor charges again. Let T_{transfer} be the time it took for the capacitor voltage to drop from V_{H} to V_{L}. To achieve energy balance, the load energy equals the energy from capacitor plus the energy from EM transducer, which is given by:

$${\int }_{{T}_{transfer}} {p}_{load} ( t ) \cdot ⅆ t = ( \frac{1}{2} {CV}_{H}^{2} - \frac{1}{2} {CV}_{L}^{2} ) + {\int }_{{T}_{transfer}} {p}_{in} ( t ) \cdot ⅆ t$$

where pᵢₙ(t) is the instantaneous AC power from the electromagnetic transducer.

Since the capacitor voltage dropped from V_{H} to V_{L}, the energy that it provided to the regulator is the same as it stored during the energy storage phase. Energy stored in the capacitor during the storage phase is provided to the load in the transfer phase along with additional energy from the input to meet the load requirement. There is complete energy harvesting from the transducer although it is provided to the load in an intermittent, “quasi-continuous” manner.

In other words, the capacitor discharges because the electromagnetic transducer cannot support the load on its own. The capacitor is called on to provide the difference. If, however, iᵢₙ=iₒᵤₜ during the energy transfer phase, the capacitor current i_{C} reduces to zero and its voltage stays constant. Energy from the capacitor is no longer used and all the load power is supported by the input. Because the input power drawn from the transducer is determined by the load power and losses in the power converter, the DC link capacitor can only be recharged when power transfer to the load is suspended.

The upper and lower thresholds are programmed based on knowledge of both the unregulated AC electrical energy supplied by the mechanical excitation force and the load requirements. It is generally desirable to have a wide hysteresis window 34 to increase the likelihood that the device will settle at an operating point at which the load power can be continuously provided by the input mechanical excitation, at least locally. This will occur when the capacitor voltage, coil current, magnetic velocity are such that the restraining force is exactly balanced by the input excitation force. The constraints are that the lower threshold VL must be high enough to avoid stalling the energy harvesting device 12 and the severe disruption in power transfer that follows and the upper threshold VH should be low enough that it is reached in a reasonable period of time.

Let us take a battery charging example. Let the regulator be programmed to charge a battery at 4V and 1 A, i.e. 4 W of DC power. After the DC link capacitor voltage exceeds V_{H} say 20V, the hysteretic controller tells the regulator, “Go ahead and start charging the battery.” The regulator replies, “Ok” and starts drawing 4 W from the coils. Let us assume that after losses 5 W is drawn from the DC link cap. This 5 W draw of power will result in the flow of current through the coil and hence the creation of a restraining force. If the restraining force is greater than the excitation force, the magnets will slow down causing the DC link voltage to drop. In other words, the capacitor is required to source energy to augment the energy provided by the energy harvesting device to supply the power demanded by the load. Once the voltage drops below V_{L}, say after 5 secs, the hysteretic controller is going to tell the regulator to stop because the voltage is dropping too fast and the energy harvesting device may soon stall. The DC link voltage starts building up say for 5 more secs and hits the upper limit V_{H} when the hysteretic controller gives the ok signal again. Assuming this cycle continues for a period of time, 4 W of load power is drawn for 5 out of every 10 secs (50% duty cycle). Hence, an average power of 2 W is drawn from the input. This type of situation is depicted in FIG. 5a where the capacitor voltage 32 ramps up and down between the thresholds to deliver load power 44 at a 50% duty cycle.

Now let us assume that the load draws less power, e.g. the battery is nearly charged, and/or the energy harvesting device supplies more power for some extended period of time. As shown in FIG. 5b, the capacitor voltage charges up until it reaches V_{H} and then power transfer begins. Initially some energy is drawn from the capacitor but then the power converter settles at an operating point 46a where the load power can be continuously provided by the input mechanical excitation. At some point, the capacitor starts sourcing energy to make up for a shortfall from the mechanical excitation and the capacitor voltage drops further until the power converter settles at another operating point 46b. This continues until the capacitor voltage falls below V_{L}, suspending power transfer and recharging the capacitor from the mechanical excitation.

By setting the lower threshold V_{L} at an appropriate level, the power converter avoids stalling the energy harvesting device 12 and minimizes regulator losses. First, if the restraining force were allowed to overwhelm the excitation force causing the magnetics to stop moving and driving the capacitor voltage to zero, no power could be transferred to the load. Second, the regulator typically delivers the required power to the load at a regulated voltage over a wide range of DC link capacitor voltages. If the capacitor voltage is low the capacitor will have to source more current to supply the required power, which increases the losses within the regulator and reduces efficiency.

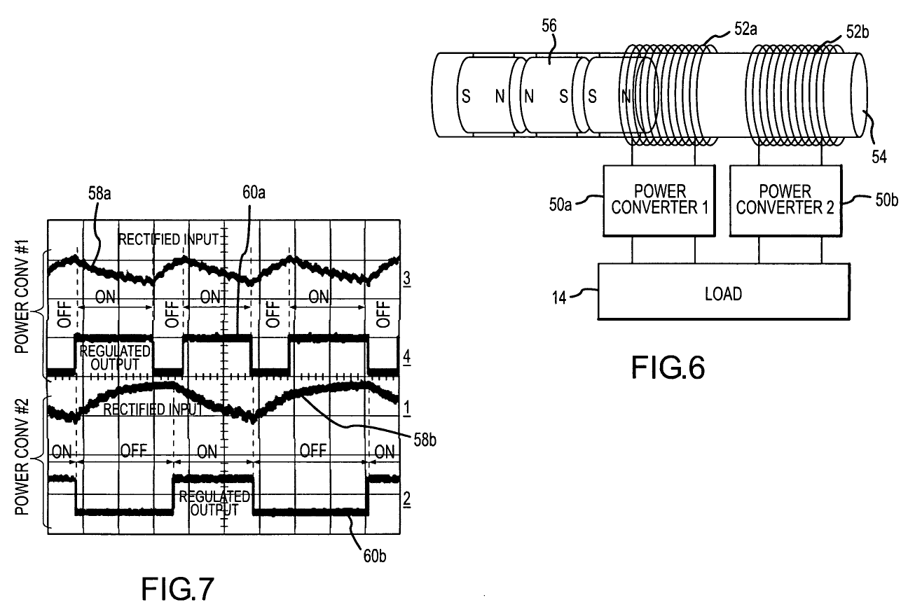

As illustrated in FIGS. 6 and 7 a plurality of power converters 50a and 50b may be used to harvest the AC electrical energy by shifting them in phase with respect to each other and adding their regulated outputs at the terminals of load 14. The desired phase shift is achieved by connecting power converters 50a and 50b to respective conductive coils 52a and 52b that are spaced apart along tube 54. As magnets 56 move back and forth through the coils in a reciprocating motion they induce AC voltages across the terminals of their respective coil that are out of phase. In turn, these voltages produce unregulated capacitor voltages 58a and 58b that are phase shifted and deliver power 60a and 60b to the load that are phase shifted. Summing the phase shifted power from multiple coils achieves a more continuous transfer of power to the load.

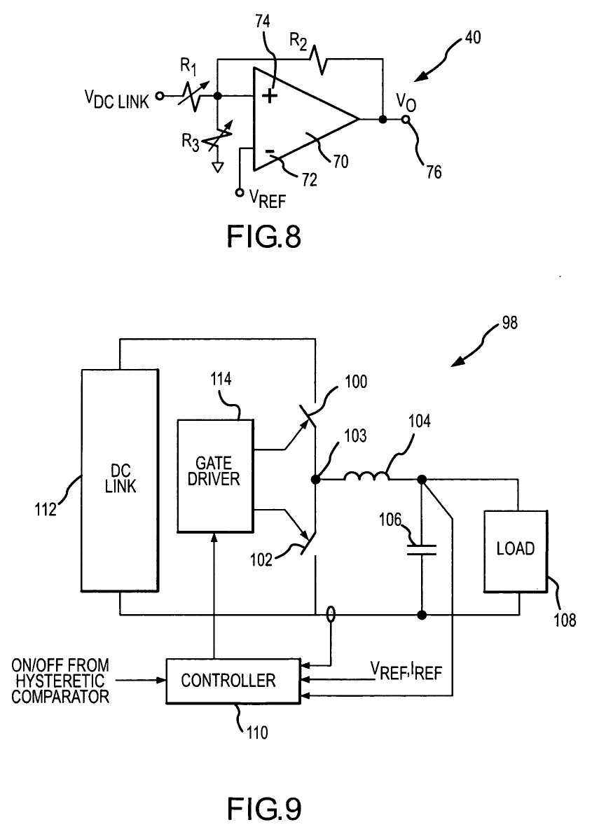

FIG. 8 is an embodiment of a simple operational amplifier based hysteretic comparator 40. The comparator includes an op-amp 70 having inverting and non-inverting inputs 72 and 74, respectively, and an output 76. Resistor R₁ is connected between non-inverting input 74 and the DC link capacitor. Resistor R₂ is connected between non-inverting input 74 and output 76. Resistor R₃ is connected between non-inverting input 74 and ground. A reference voltage V_{ref} is supplied to inverting input 72. The lower and upper thresholds are programmed according to:

$${V}_{L} = {V}_{ref} ( 1 + \frac{{R}_{1}}{{R}_{2}} + \frac{{R}_{1}}{{R}_{3}} ) - {V}_{0} \frac{{R}_{1}}{{R}_{2}} , and$$

$${V}_{H} = {V}_{ref} ( 1 + \frac{{R}_{1}}{{R}_{2}} + \frac{{R}_{1}}{{R}_{3}} ) .$$

The lower and upper thresholds are varied by adjusting R1, R2 and R3.

Let us assume the power converter is in the energy storage phase. Output voltage V0 is low thereby turning the regulator off. The output voltage V0 stays low until the capacitor voltage exceeds VH, at which point the voltage at the non-inverting input 74 is greater than Vref at inverting input 72 causing the op-amp to switch the output voltage V0 high. The high output signal from the comparator turns on the regulator to transfer power from the DC link capacitor to the load. The output voltage V₀ stays high until the capacitor voltage falls below V_{L}, at which point the voltage at the non-inverting input 74 is less than V_{ref} at inverting input 72 causing the op-amp to switch the output voltage V₀ low and consequently shutdown the regulator from transferring power to the load allowing the capacitor to recharge from the input excitation.

The regulator 36 can be a linear regulator or a switching power converter 98 of, for example, the type shown in FIG. 9. The voltage step down switching power converter 98 consists of two controllable switches 100 and 102, a filter inductor 104, an output filter capacitor 106 connected across the load 108. The gate driver 114 generates the driving signals to turn the switches 100 and 102 on and off in order to regulate the output capacitor voltage. The gate driver generates complementary driving signals for the switches 100 and 102, i.e. when switch 100 is turned on, switch 102 is turned off and vice versa. The switches 100 and 102 could be operated at a constant or variable frequency according to the application. When switch 100 is on and switch 102 is off, the DC link voltage is applied at terminal 103. The ratio of the on-duration of switch 100 to the switching period is called the duty cycle of the converter.

The voltage across the inductor is then equal to the difference between the voltage across the DC link capacitor 112 and output capacitor voltage. With the DC link voltage greater than the output capacitor voltage, the inductor current increases during this period. When the switch 102 is on and switch 100 is off, the inductor voltage is equal to the negative of the output capacitor voltage. Hence, the inductor current decreases during this period. The average inductor voltage over a switching period has to be equal to zero. Under this constraint, the output capacitor voltage is equal to the product of the DC link voltage and the duty cycle of the converter. Hence, the output capacitor voltage can be controlled by varying the duty cycle of switch 100.

The controller 110 measures the output voltage and inductor current. In response to a control objective, which may be to regulate output voltage, inductor current or both, the controller supplies a duty cycle command to the gate driver. The gate driver 114 converts the duty cycle command into corresponding driving signals for switches 100 and 102 such that the control objective is met. The controller can command the gate driver to shut down the driving signals to both switches when the hysteretic controller senses that the DC link capacitor voltage has reached its lower threshold value and switch to power transfer and output power regulation mode when the DC link capacitor voltage reaches the upper threshold. The frequencies at which the devices 100 and 102 are turned on and off is set to be very high compared to the frequency of input mechanical excitation. This enables reduction in the size and weight of the passive components such as the inductor 104 and output capacitor 106 resulting in high power density.

In an alternate embodiment, the switching converter may be configured to adjust the power provided to the load by monitoring the DC link voltage. If the DC link voltage drops too fast, the switching converter can be controlled to reduce the power drawn and allow the DC link voltage to build up or stabilize. This option requires increased control capability which may require more processing power and is a more complex system. The current solution is a simple, bang-bang type of control.

While several illustrative embodiments of the invention have been shown and described, numerous variations and alternate embodiments will occur to those skilled in the art. Such variations and alternate embodiments are contemplated, and can be made without departing from the spirit and scope of the invention as defined in the appended claims.

I claim:

1. An energy harvesting system for delivering power to a load, comprising:
an energy harvesting device that converts mechanical excitation energy into unregulated AC electrical energy in the form of an AC signal;
a rectifier that rectifies the AC signal;
a DC link capacitor that integrates and stores energy from said rectified AC signal; and
control electronics that alternately transfers regulated power to the load and recharges the capacitor in accordance with a hysteresis in the capacitor energy.

2. The energy harvesting system of claim 1, wherein the energy harvesting device is a piezoelectric transducer or an electromagnetic transducer.

3. The energy harvesting system of claim 1, wherein said control electronics terminates transfer of regulated power to the load and initiates charging of the DC link capacitor when the capacitor energy falls below a lower hysteresis threshold and terminates capacitor charging and initiates power transfer when the capacitor energy exceeds an upper hysteresis threshold.

4. The energy harvesting system of claim 3, wherein the lower hysteresis threshold is set to prevent the energy harvesting device from stalling and temporarily suspending generation of the unregulated AC electrical energy.

5. The energy harvesting system of claim 3, wherein the upper hysteresis threshold is set to increase the likelihood of the system settling at an operating point within the hysteresis window at which continuous transfer of regulated power to the load can be achieved.

6. The energy harvesting system of claim 3, wherein the DC link capacitor integrates a plurality of cycles of said unregulated AC signal to store energy.

7. The energy harvesting system of claim 3, wherein the control electronics comprise:
a regulator that converts an unregulated DC voltage across the DC link capacitor to a regulated electrical signal as required by the load; and
a hysteretic comparator that turns the regulator on when the unregulated DC voltage exceeds the upper hysteresis threshold and off when the unregulated DC voltage falls below the lower hysteresis threshold.

8. The energy harvesting system of claim 7, wherein the thresholds are programmable.

9. The energy harvesting system of claim 7, wherein the regulator comprises a switching converter.

10. The energy harvesting system of claim 9, wherein the switching converter converts the unregulated DC voltage into a set regulated DC signal to deliver regulated power up to a set amount.

11. The energy harvesting system of claim 10, wherein the switching converter converts the unregulated DC voltage over a range that spans the lower and upper thresholds into the set regulated DC signal.

12. The energy harvesting system of claim 3, wherein the energy stored in the DC link capacitor during an energy storage cycle equals the energy transferred from the DC link capacitor to the load in an energy transfer cycle.

13. The energy harvesting system of claim 1, further comprising a voltage regulator that extracts energy from the DC link capacitor to provide bias power to the control electronics.

14. The energy harvesting system of claim 1, further comprising a plurality of DC link capacitors and control electronics that receive the unregulated AC electrical energy shifted in phase from each other.

15. A power converter, comprising:
a DC link capacitor;
a rectifier for rectifying an AC signal and charging the DC link capacitor to generate an unregulated DC voltage;
a regulator that converts the unregulated DC voltage into a regulated electrical signal; and
a hysteretic comparator that turns the regulator on when the unregulated DC voltage exceeds an upper threshold and off when the unregulated DC voltage falls below a lower threshold.

16. The power converter of claim 15, wherein the comparator thresholds are programmable.

17. The power converter of claim 15, wherein the regulator comprises a switching converter that converts the unregulated DC voltage into a set regulated DC signal to deliver regulated power up to a set amount.

18. The power converter of claim 15, further comprising a voltage regulator that extracts energy from the DC link capacitor to provide bias power to the power converter.

19. An energy harvesting system for delivering power to a load, comprising:
an energy harvesting device that converts mechanical excitation energy into an unregulated AC signal;
a DC link capacitor;
a rectifier that rectifies the unregulated AC signal and charges the DC link capacitor to generate an unregulated DC voltage;
a regulator that converts the unregulated DC voltage into a regulated electrical signal that is supplied to the load; and
a hysteretic comparator that turns the regulator on when the unregulated DC voltage exceeds an upper threshold and off when the unregulated DC voltage falls below a lower threshold.

20. The energy harvesting system of claim 19, wherein the regulator comprises a switching converter the converts the unregulated DC voltage into a set regulated DC signal to deliver regulated power up to a set amount.

21. The energy harvesting system of claim 19, wherein the energy stored in the DC link capacitor during an energy storage cycle equals the energy transferred from the DC link capacitor to the load in an energy transfer cycle.

22. A method of converting unregulated AC electrical energy into regulated power, comprising:
storing energy from an unregulated AC source in a DC link capacitor, and
alternately transferring regulated power to a load and recharging the capacitor in accordance with a hysteresis in the capacitor energy.

23. The method of claim 22, wherein the transfer of regulated power to the load is terminated and recharging of the DC link capacitor is initiated when the capacitor energy falls below a lower hysteresis threshold and recharging of the capacitor is terminated and power transfer initiated when the capacitor energy exceeds an upper hysteresis threshold.

24. The method of claim 22, wherein energy stored in the DC link capacitor during an energy storage cycle equals the energy transferred from the DC link capacitor to the load in an energy transfer cycle.

25. The method of claim 22, further comprising setting the lower hysteresis threshold to prevent the energy harvesting device from stalling and temporarily suspending generation of the unregulated AC electrical energy.

26. The method of claim 22, further comprising setting the upper hysteresis threshold to increase the likelihood of settling at an operating point within the hysteresis window where continuous transfer of regulated power to the load can be achieved.
